(19) United States
(12) Patent Application Publication
(10) Pub. No.: US 2026/0203154 A1
(43) Pub. Date: Jul. 16, 2026

(54) CLOUD COMPUTING INTEGRATION SUITE MESSAGE RECORDER

(71) Applicant: SAP SE, Walldorf (DE)

(72) Inventors: Deepak G. DESHPANDE, Bengaluru (IN); Prasanth Ganesh RAO, Bangalore (IN); Saranya BASKARAN, Bangalore (IN); Sana FARAZ, Bangalore (IN)

(21) Appl. No.: 19/016,133

(22) Filed: Jan. 10, 2025

(51) Int. Cl. G06F 11/07

(52) U.S. Cl. CPC G06F 11/0784; G06F 11/0709

(57) ABSTRACT

A system associated with a cloud computing environment includes a message interceptor that intercepts details of messages of a process executed by an enterprise. The message interceptor then determines an occurrence of a process failure, and, responsive to the determination, automatically records details of the intercepted messages that may be relevant to the process failure. A collected message data store contains details of the intercepted messages that may be relevant to the process failure. A message recorder can then access the collected message data store and arrange for information about the recorded messages to be transmitted to a support team. In some embodiments, the message recorder also provides at least some of the information about the relevant messages to a LLM (e.g., via a prompt that includes some of a process code base), and a response includes possible troubleshooting information to fix the code base.

### BACKGROUND

An enterprise may implement processes. For example, a company may implement business processes to handle sales orders, item deliveries, inventory monitoring, etc. Moreover, the processes may be automated in a cloud computing environment using integration models. There are many software applications and products that are based on such models where a developer creates a sequence of events or processes and the appropriate sequence of flow steps for the process. When a business process failure occurs, a developer or support team troubleshooter may need to investigate multiple communications (e.g., events or messages) to collect the correct data that might be related to the issue or bug. This process may take a substantial amount of time (which increases the turnaround time for problem resolution).

For example, an integration Platform-as-a-Service (“iPaaS”) may help a business quickly integrate on-premise and cloud-based processes, services, applications, events, and data. There may be situations when message processing fails for various reasons. Typically, the collection of failure details (e.g., log content, inbound and outbound process payloads, integration scenario, cloud instance system details such as memory consumption, java traces and java thread dumps, etc.) is a reactive process. A support team generally asks a customer to enable an application trace log level and re-run the process. If more details are required, there may be a back-and-forth communication until the support team feels that they received enough data to assess the issue and provide consultation guidance, troubleshooting steps to fix the issue, or a code fix to resolve the bug. The amount of time spent in ping-ponging for the issue or ticket and the overall turnaround time for resolving the issue can be substantial and costly – especially when there are a substantial number of processes, the processes are very complicated, etc.

It would therefore be desirable to record and analyze process messages in a secure, automatic, and efficient manner.

### SUMMARY

According to some embodiments, methods and systems associated with a cloud computing environment may include a message interceptor that intercepts details of messages of a process executed by an enterprise. The message interceptor then determines an occurrence of a process failure, and, responsive to the determination, automatically records details of the intercepted messages that may be relevant to the process failure. A collected message data store contains details of the intercepted messages that may be relevant to the process failure. A message recorder can then access the collected message data store and arrange for information about the recorded messages to be transmitted to a support team. In some embodiments, the message recorder also provides at least some of the information about the relevant messages to a large language model (e.g., via a prompt that includes some of a process code base), and a response to the prompt may include possible troubleshooting information to fix the code base.

Some embodiments comprise: means for intercepting, by a computer processor of a message interceptor, details of messages associated with a process executed by an enterprise in the cloud computing environment; means for determining, by the computer processor of the message interceptor, an occurrence of a process failure; responsive to said determination, means for automatically recording details of the intercepted messages that may be relevant to the process failure in a collected message data store that contains electronic records representing details of the intercepted messages that may be relevant to the process failure; means for accessing, by a message recorder, information from the collected message data store; and means for arranging, by the message recorder, for information about the recorded messages to be transmitted, via a distributed communication network, to a support team via a Graphical User Interface (“GUI”) display.

Some technical advantages of some embodiments disclosed herein are improved systems and methods to record and analyze process messages in a secure, automatic, and efficient manner.

### BRIEF DESCRIPTION OF THE DRAWINGS

FIG. 1A is a high-level system architecture for message recording in accordance with some embodiments.

FIG. 1B is an example of a business process, including messages, in accordance with some embodiments.

FIG. 2 is a method according to some embodiments.

FIG. 3 is a more detailed message interceptor system for message recording in accordance with some embodiments.

FIG. 4 is a more detailed message recorder system for message recording according to some embodiments.

FIG. 5 is a more detailed message recorder system for message recording in accordance with some embodiments.

FIG. 6 is a generative artificial intelligence method in accordance with some embodiments.

FIG. 7 is an apparatus or platform according to some embodiments.

FIG. 8 is a portion of a collected message database in accordance with some embodiments.

FIG. 9 is a more detailed architecture approach for a system according to some embodiments.

FIG. 10 illustrates a tablet computer integration suite message recorder display in accordance with some embodiments.

FIG. 11 is an integration suite message recorder operator or administrator display according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

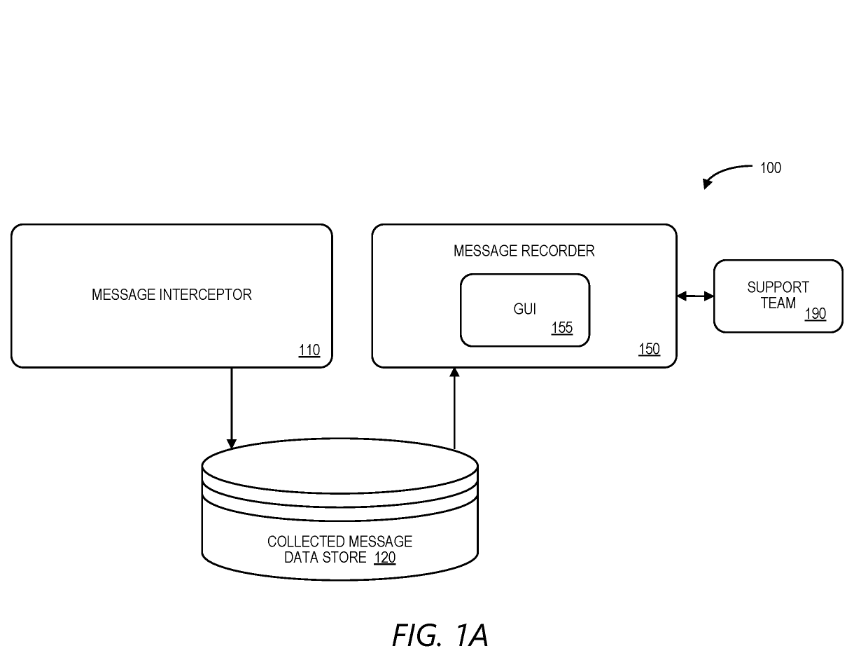

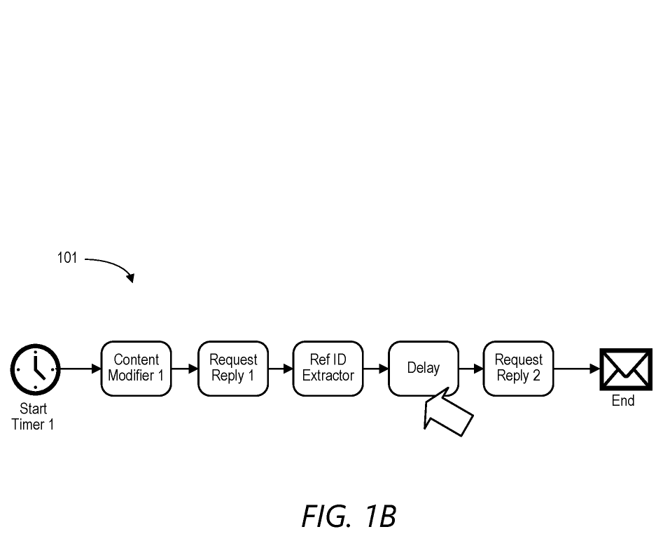

FIG. 1A is a high-level block diagram of one example of a system 100 architecture for message recording according to some embodiments. In particular, a message interceptor 110 may store information about business process messages into a collected message data store 120. FIG. 1B is an example of a business process 101, including messages, in accordance with some embodiments. The business process flow might, for example, be stored as a Business Process Management Notation (“BPMN”) diagram at design time and an APACHE™ Camel® document at runtime. Camel® is an open-source framework for message-oriented middleware with a rule-based routing and mediation engine that provides a Java object-based implementation of the enterprise integration pattern using an application programming interface to configure message routing and mediation rules.

Referring again to FIG. 1A, a message recorder and analyzer 150 may access information from the collected message data store 120. The message recorder and analyzer 150 can then use that information to automatically perform one or more various actions as described herein. As used herein, the term “automatically” may refer to something that is performed with little or no human intervention. The message recorder and analyzer 150 may, in some embodiments, utilize a Graphical User Interface (“GUI”) 155 to exchange information with a support team 190. According to some embodiments, a remote operator or administrator device may be used to configure or otherwise adjust the system 100 (e.g., to provide message collection rules, logic, or options).

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The message recorder and analyzer 150 may store information into and/or retrieve information from various data stores (e.g., the collected message data store 120), which may be locally stored or reside remote from the message recorder and analyzer 150. Although a single message recorder and analyzer 150 is shown in FIG. 1A, any number of such devices may be included. Moreover, various devices described herein might be combined according to embodiments of the present invention. For example, in some embodiments, the collected message data store 120 and the message recorder and analyzer 150 might comprise a single apparatus. The system 100 functions may be performed by a constellation of networked apparatuses, such as in a distributed processing or cloud-based architecture. In some cases, the message recorder and analyzer 150 may process information associated with a number of different enterprises.

The enterprise may access the system 100 via a remote device (e.g., a Personal Computer (“PC”), tablet, or smartphone) to view information about and/or manage operational information in accordance with any of the embodiments described herein. In some cases, the interactive GUI155 may let an operator or administrator define and/or adjust certain parameters via a remote device (e.g., to define an action for an enterprise computing environment infrastructure) and/or provide or receive automatically generated recommendations, alerts, summaries, or results associated with the system 100 and business process failures.

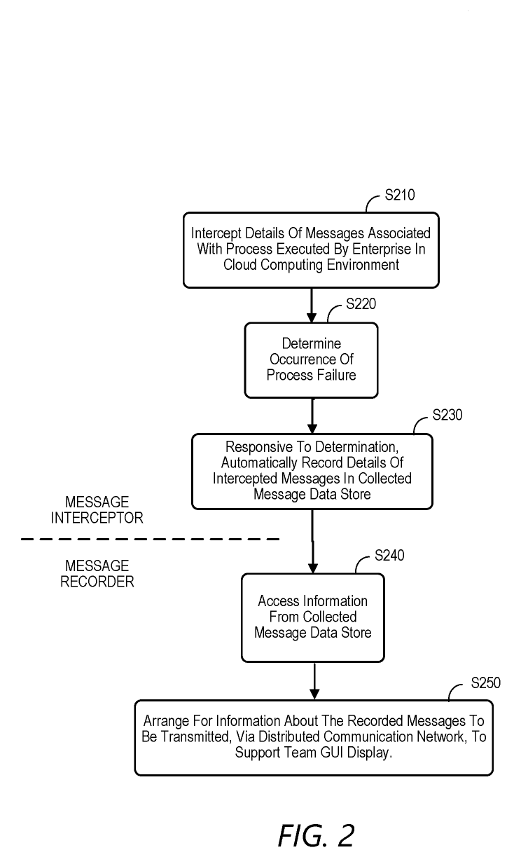

FIG. 2 is a method that might be performed by some or all of the elements of the system 100 described with respect to FIG. 1A. The flow charts described herein do not imply a fixed order to the steps, and embodiments of the present invention might instead be practiced in any order that is practicable. Note that any of the methods described herein may be performed by hardware, software, or any combination of these approaches. For example, a computer-readable storage medium may store thereon instructions that when executed by a machine result in performance of a method according to any of the embodiments described herein.

At S210, a computer processor of a message interceptor may intercept details of messages associated with a process executed by an enterprise in a cloud computing environment. The process might comprise, for example a business application integration scenario, and the message interceptor may be part of a message processing component of the business application integration scenario.

At S220, the computer processor of the message interceptor may determine an occurrence of a process failure. Responsive to this determination, at S230 the message interceptor may automatically record details of the intercepted messages that might be relevant to the process failure in a collected message data store. The collected message data store may, for example, contain electronic records representing details of the intercepted messages that might be relevant to the process failure. The collected message data store might be associated with, for example, a distributed event streaming platform, a shared file system, etc. The details of the messages associated with the process might include, for example, an integration scenario identifier, a message time, exception trace logs, payloads, memory usage, computing resource utilization, bandwidth or other types of Input Output (“IO”) data, etc.

At S240, a message recorder may access information from the collected message data store. In some embodiments, the message recorder is further to de-serialize information from the collected message data store. At S250, the message recorder may arrange for information about the recorded messages to be transmitted, via a distributed communication network, to a support team via a GUI display. The message recorder may also provide at least some of the information about the recorded messages to a generative Artificial Intelligence (“GenAI”) Large Language Model (“LLM”). In some embodiments, a LLM prompt includes at least some code base of the process executed by the enterprise. Moreover, a response received from the LLM might include possible troubleshooting information that could be used to help fix the code base.

Note that at least one of the message interceptor and the message recorder might comprise a component that is plugged into cloud applications for the design, development, and/or execution of business processes and/or be associated with the SAP™ Integration Suite® - Cloud Integration platform of the Business Technology Platform® (“BTP”). Moreover, at least one of the message interceptor and the message recorder could comprise a reuseable component that communicates with pre-trained LLMs to generate a set of solution proposals based on real-time incident data.

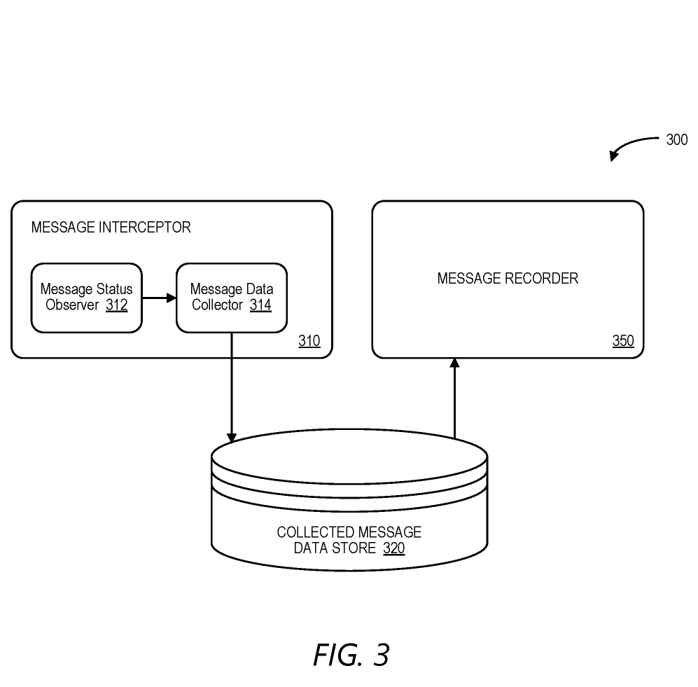

FIG. 3 is a more detailed message interceptor system 300 for message recording in accordance with some embodiments. As before, a message interceptor 310 may store information about business process messages into a collected message data store 320. A message recorder and analyzer 350 can then access information from the collected message data store 320 and use the information to automatically perform one or more various actions as described herein. In this case, the message interceptor 310 includes a message status observer 312 and a message data collector 314. To some extent, the system 300 parallels that of a flight recorder (also called a “black box”) – it attempts to record all of the relevant details when a message failure happens to get the real-time data that could be relevant to a process failure being investigated by a support team. The message interceptor 310 may, in some embodiments, be part of an existing message processing component that intercepts the details of a message. The message status observer 312 may observe the message status and, upon detection of a message status failure, trigger the message data collector 314. The message data collector 314 gathers all of the relevant data (integration scenario, logs, payloads, memory usage, etc.), serializes it, and stores it into the collected message data store 320.

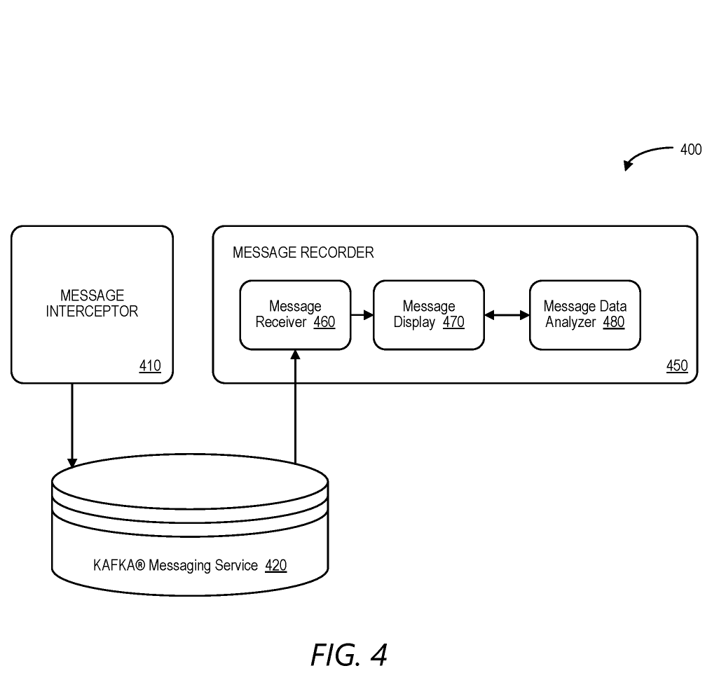

FIG. 4 is a more detailed message recorder system 400 for message recording according to some embodiments. As before, a message interceptor 410 may store information about business process messages into a KAFKA® messaging service 420. A message recorder 450 can then access information from the KAFKA® messaging service 420 and use the information to automatically perform one or more various actions as described herein. The message recorder 450 is responsible for getting and displaying the failed message details. The message recorder 450 includes a message receiver 460 that retrieves and de-serializes the data from the KAFKA® messaging service 420 (or shared file location). The de-serialized information is supplied to a message display 470 that renders the data (e.g., to a support team including an integration scenario name, payloads, exception trace, memory usage, etc.) and a message data analyzer 480. Although KAFKA® is used herein as an example, note that embodiments may store information into any messaging service, a database associated with an enterprise Platform-as-a-Service (“PaaS”) for application development services and capabilities to build, extend, and/or integrate business applications in the cloud, e tc.

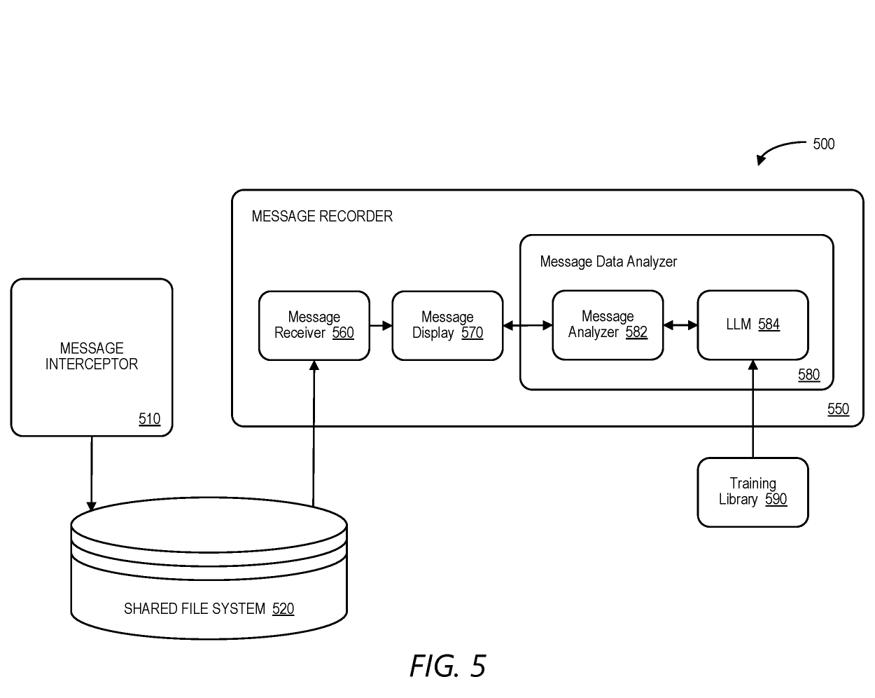

FIG. 5 is a more detailed message recorder system 500 for message recording in accordance with some embodiments. As before, a message interceptor 510 may store information about business process messages into a shared file system 520. A message recorder 550, including a message receiver 560 and message display 570, can then access information from the shared file system 520 and use the information to automatically perform one or more various actions as described herein. In this case, a message data analyzer 580 includes a message analyzer 580 that takes the data, selects one or more specific parts (e.g., exception trace data), performs prompt-engineering, and sends a request to an LLM584 (e.g., specifically trained with information from a library 590). A response from the LLM584 can then be sent back to the message display 570 to render the data for a support team.

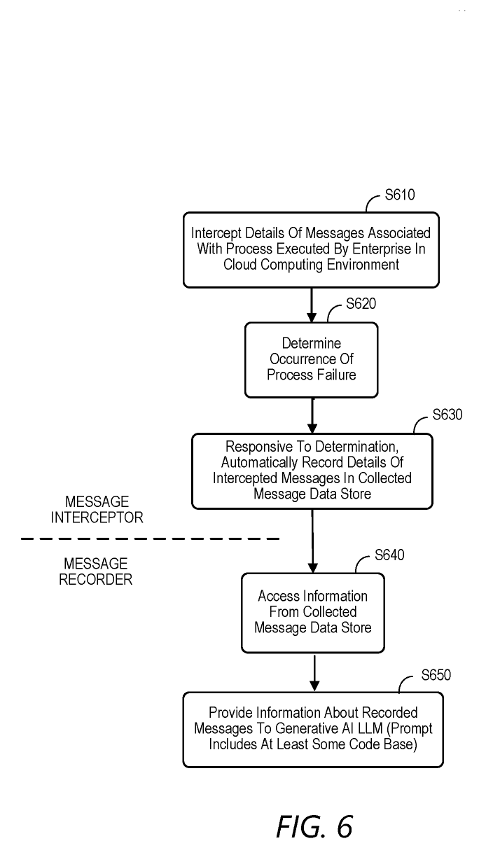

FIG. 6 is a generative artificial intelligence method in accordance with some embodiments. As before, at S610 a message interceptor may intercept details of messages associated with a process executed by an enterprise in a cloud computing environment. The process might comprise, for example a business application integration scenario, and the message interceptor may be part of a message processing component of the business application integration scenario.

At S620, the message interceptor may determine an occurrence of a process failure. Responsive to this determination, at S630 the message interceptor may automatically record details of the intercepted messages that might be relevant to the process failure in a collected message data store. At S640, a message recorder may access information from the collected message data store. At S650, the message recorder may arrange for information about the recorded messages to be transmitted to a GenAI LLM. As used herein, the phrase “LLM” may refer to a model designed for natural language processing tasks (e.g., language generation) by learning statistical relationships from substantial amounts of text during a self-supervised and semi-supervised training process. In some embodiments, a LLM prompt includes at least some code base of the process executed by the enterprise. Moreover, a response received from the LLM might include possible troubleshooting information that could be used to help fix the code base. This may significantly reduce the time and effort spent troubleshooting a business process failure. According to some embodiments, the response further includes a meaningful troubleshooting guide and/or suggestions about possible code fixes.

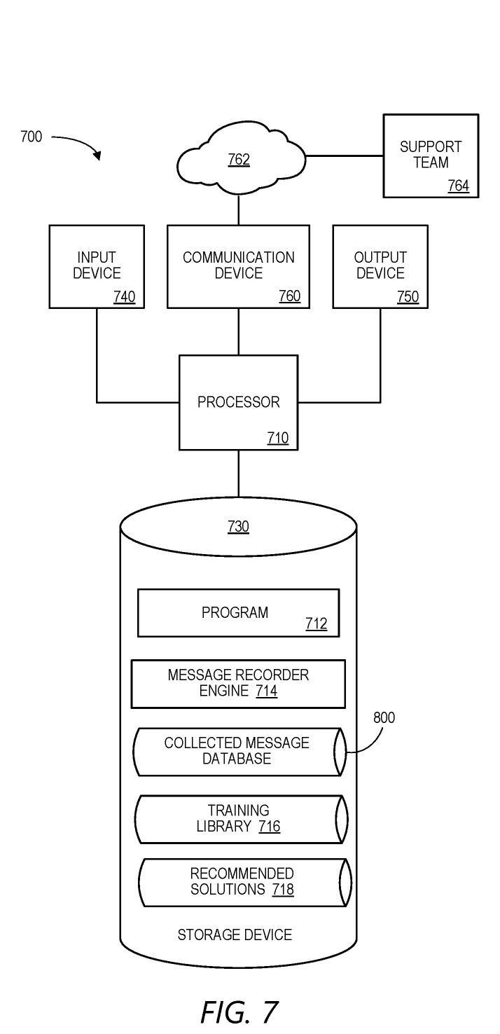

Note that the embodiments described herein may be implemented using any number of different hardware configurations. For example, FIG. 7 is a block diagram of an apparatus or platform 700 that may be, for example, associated with the system 100 of FIG. 1A (and/or any other system described herein). The platform 700 comprises a processor 710, such as one or more commercially available Central Processing Units (“CPUs”) in the form of one-chip microprocessors, coupled to a communication device 760 configured to communicate via a communication network 762. The communication device 760 may be used to communicate, for example, with one or more support team devices 764 via a distributed computer network 762. The platform 700 further includes an input device 740 (e.g., a computer mouse and/or keyboard to input integration file information, troubleshooting options, etc.) and/an output device 750 (e.g., a computer monitor to render a display, transmit recommendations, charts, alerts, and/or reports about business process failure, etc.).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or message recorder engine 714 for controlling the processor 710. The processor 710 performs instructions of the programs 712, 714, and thereby operates in accordance with any of the embodiments described herein. For example, the processor 710 may intercept details of messages of a process executed by an enterprise. The processor 710 then determines an occurrence of a process failure, and, responsive to the determination, automatically record details of the intercepted messages that may be relevant to the process failure. The processor 710 can then access the collected message data store and arrange for information about the recorded messages to be transmitted to a support team. In some embodiments, the processor 710 also provides at least some of the information about the relevant messages to a LLM (e.g., via a prompt that includes some of a process code base), and a response includes possible troubleshooting information to fix the code base.

The programs 712, 714 may be stored in a compressed, uncompiled and/or encrypted format. The programs 712, 714 may furthermore include other program elements, such as an operating system, clipboard application, a database management system, and/or device drivers used by the processor 710 to interface with peripheral devices.

As used herein, information may be “received” by or “transmitted” to, for example: (i) the platform 700 from another device; or (ii) a software application or module within the platform 700 from another software application, module, or any other source.

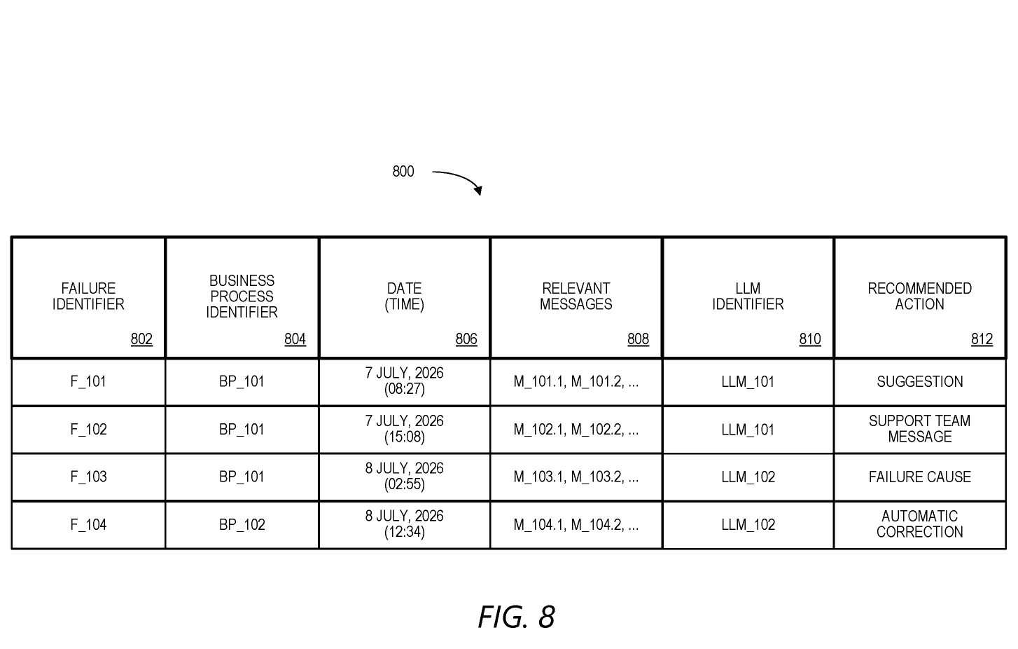

In some embodiments (such as the one shown in FIG. 7), the storage device 730 further stores a collected message database 800, a training library 716 (e.g., containing information used to train LLMs to handle various business processes), recommended solutions 718, etc. An example of a database that may be used in connection with the platform 700 will now be described in detail with respect to FIG. 8. Note that the database described herein is only one example, and additional and/or different information may be stored therein. Moreover, various databases might be split or combined in accordance with any of the embodiments described herein.

Referring to FIG. 8, a table is shown that represents the collected message database 800 that may be stored at the platform 700 according to some embodiments. The table may include, for example, entries identifying business process failures to be analyzed. The table may also define fields 802, 804, 806, 808, 810, 812 for each of the entries. The fields 802, 804, 806, 808 may, according to some embodiments, specify: a failure identifier 802, a business process identifier 804, a date and time 806, relevant messages 808, a LLM identifier 810, and a recommended action 812. The collected message database 800 may be created and updated, for example, when a business process failure is detected, reported, generates a response, etc.

The failure identifier 802 might be a unique alphanumeric label that is associated with a problem that has been detected with a business process. The business process identifier 804 might identify the business process failure (e.g., including an enterprise name, program name, etc.) and the date and time 806 might indicate when the problem occurred. The relevant messages 808 may reflect the relevant messages that were being processed and captured when the failure happened. The LLM identifier 810 might indicate a specific GenAI model that has been trained to handle the business process identifier 804 (e.g., using code from that process). The recommended action 812 might comprise a suggestion (e.g., do not allow that type of message in this particular circumstance), a support team message that is automatically generated and transmitted, a description of the failure and likely causes, code corrections that can be automatically implemented, etc.

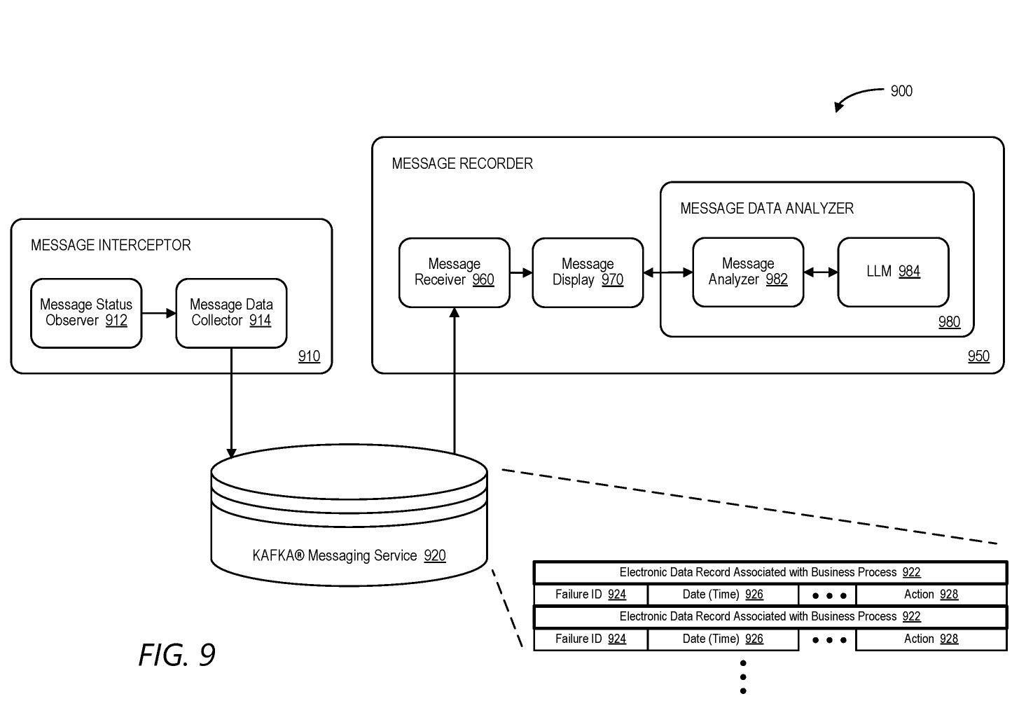

FIG. 9 is a more detailed architecture approach for a system 900 according to some embodiments. A message interceptor 910, including a message status observer 912 and message data collector 914, stores information about business process messages into a KAFKA® messaging service 920. The APACHE™ KAFKA® is a distributed event store and stream-processing platform. It is an open-source system developed in Java and Scala to provide a unified, high-throughput, low-latency platform for handling real-time data feeds. The KAFKA® messaging service 920 might store, for example, electronic data records associated with business processes 922, including a failure identifier 924, a date and time 916, a recommended action 928, etc. According to some embodiments, the KAFKA® messaging service 920 can connect to external systems (e.g., to support data import and/or export operations). Moreover, the KAFKA® messaging service 920 might provide libraries for stream processing applications and use a binary TCP-based protocol that is optimized for efficiency (and relies on a “message set” abstraction that groups messages together to reduce network roundtrip overhead). A message recorder 950, including a message receiver 960 and message display 970, can then access information from the KAFKA® messaging service 920 and use the information to automatically perform one or more various actions as described herein. In this case, a message data analyzer 980 includes a message analyzer 982 and LLM 984 to generate suggestions for a support team. Although KAFKA® is used herein as one example, note that embodiments could instead store information into, for example, any messaging service, a database associated with an enterprise PaaS, e tc.

In some embodiments, the message recorder is associated with an integration domain, but other embodiments may be associated with other domains. Moreover, at least one of the message interceptor 910 and message recorder 950 might be plugged into other cloud applications which are meant for the design, development, and/or execution of business processes and require real-time data when an unexpected failure situation occurs during process execution. Similarly, at least one of the message interceptor 910 and message recorder 950 might be a reusable component that has the capability to communicate with LLMs and provide prompt engineering support to analyze and suggest solution proposals for the real-time process incident data. In this way, embodiments may support a platform where users develop and troubleshoot integration scenarios, deploy, and/or monitor business processes.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of process applications, any of the embodiments described herein could be applied to other types of modelling applications.

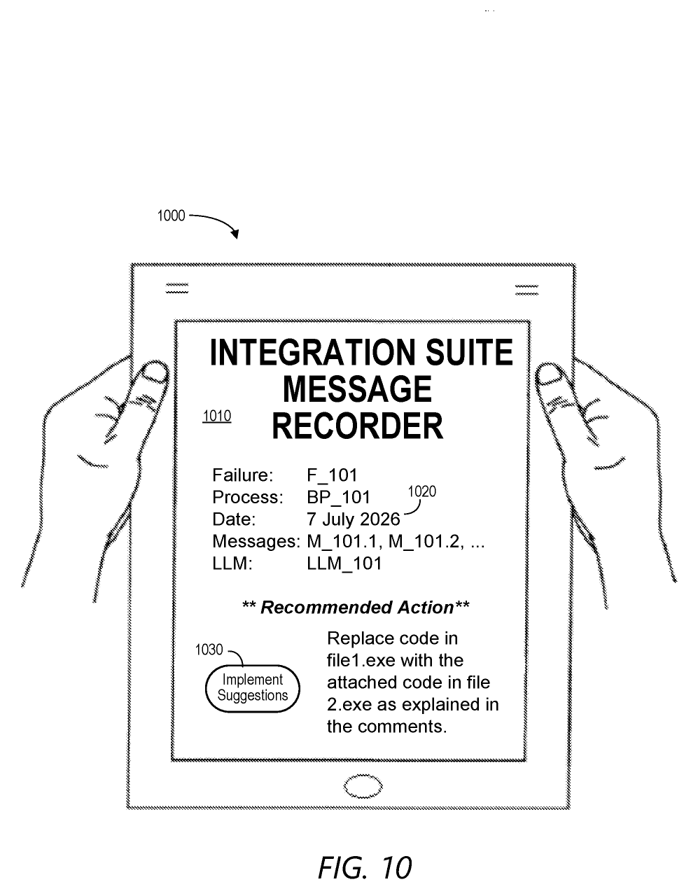

In addition, the displays shown herein are provided only as examples, and any other type of user interface could be implemented. For example, FIG. 10 illustrates a tablet computer 1000 providing an integration suite message display 1010 according to some embodiments. The display 1010 might be used, for example, to provide failure details 1020 to a support team. A user may interact with the display 1010, such as by selecting an “Implement Suggestions” icon 1030 to automatically apply recommended actions create by GenAI based on the relevant messages.

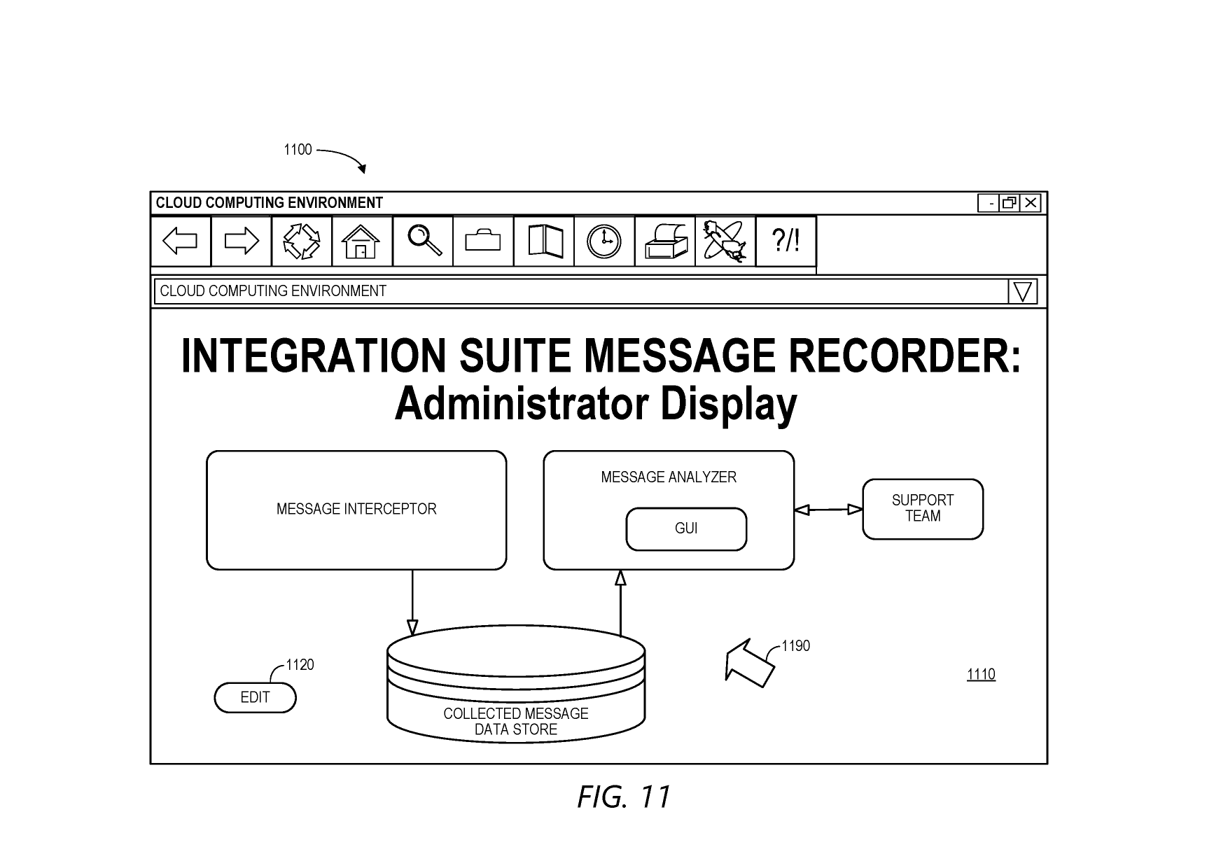

FIG. 11 is an operator or administrator display 1100 in accordance with some embodiments. The display 1100 includes a graphical representation 1110 of an integration suite message recorder in accordance with any of the embodiments described herein. Selection of an element on the display 1100 (e.g., via a touchscreen or computer pointer 1190) may result in display of a pop-up window containing more detailed information about that element and/or various options (e.g., to define how a message recorder or analyzer processes data, etc.). Selection of an “Edit” icon 1120 may also let an operator or administrator adjust the operation of the system (e.g., to change mapping to a data store, rules regulating automatic actions, threshold values, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a cloud computing environment, comprising:
a message interceptor, including:
a computer processor, and
a computer memory storing instructions that when executed by the computer processor cause the interceptor to:
intercept details of messages associated with a process executed by an enterprise in the cloud computing environment,
determine an occurrence of a process failure, and
responsive to said determination, automatically record details of the intercepted messages that may be relevant to the process failure;
a collected message data store, coupled to the message interceptor, that contains electronic records representing details of the intercepted messages that may be relevant to the process failure; and
a message recorder, coupled to the collected message data store, to access information from the collected message data store and arrange for information about the recorded messages to be transmitted, via a distributed communication network, to a support team via a Graphical User Interface (“GUI”) display.

2. The system of claim 1, wherein the collected message data store is associated with at least one of: (i) a distributed event streaming platform, and (ii) a shared file system.

3. The system of claim 1, wherein the process is a business application integration scenario and the message interceptor is part of a message processing component of the business application integration scenario.

4. The system of claim 1, wherein the details of the messages associated with the process include at least one of: (i) an integration scenario identifier, (ii) a message time, (iii) exception trace logs, (iv) payloads, (v) memory usage, (vi) computing resource utilization, and (vii) Input Output (“IO”) data.

5. The system of claim 1, wherein the message recorder is further to de-serialize information from the collected message data store.

6. The system of claim 1, wherein the message recorder provides at least some of the information about the recorded messages to a generative Artificial Intelligence (“AI”) Large Language Model (“LLM”).

7. The system of claim 6, wherein a LLM prompt includes at least some code base of the process executed by the enterprise.

8. The system of claim 7, wherein a response received from the LLM includes possible troubleshooting information to fix the code base.

9. The system of claim 8, wherein at least one of the message interceptor and the message recorder comprise a component that is plugged into cloud applications for design, development, and/or execution of business processes.

10. The system of claim 8, wherein at least one of the message interceptor and the message recorder comprise a reuseable component that communicates with pre-trained LLMs to generate a set of solution proposals based on real-time incident data.

11. A computer-implemented method associated with a cloud computing environment, comprising:
intercepting, by a computer processor of a message interceptor, details of messages associated with a process executed by an enterprise in the cloud computing environment;
determining, by the computer processor of the message interceptor, an occurrence of a process failure;
responsive to said determination, automatically recording details of the intercepted messages that may be relevant to the process failure in a collected message data store that contains electronic records representing details of the intercepted messages that may be relevant to the process failure;
accessing, by a message recorder, information from the collected message data store; and
providing, by the message recorder, at least some of the information about the recorded messages to a generative Artificial Intelligence (“AI”) Large Language Model (“LLM”), wherein a LLM prompt includes at least some code base of the process executed by the enterprise.

12. The method of claim 11, wherein the collected message data store is associated with at least one of: (i) a distributed event streaming platform, and (ii) a shared file system.

13. The method of claim 11, wherein the process is a business application integration scenario and the message interceptor is part of a message processing component of the business application integration scenario.

14. The method of claim 11, wherein the details of the messages associated with the process include at least one of: (i) an integration scenario identifier, (ii) a message time, (iii) exception trace logs, (iv) payloads, (v) memory usage, (vi) computing resource utilization, and (vii) Input Output (“IO”) data.

15. The method of claim 11, wherein the message recorder is further to de-serialize information from the collected message data store.

16. One or more non-transitory computer-readable media storing computer-executable instructions that, when executed by a computing system, cause the computing system to perform operations for a cloud computing environment, comprising:
intercepting, by a computer processor of a message interceptor, details of messages associated with a process executed by an enterprise in the cloud computing environment;
determining, by the computer processor of the message interceptor, an occurrence of a process failure;
responsive to said determination, automatically recording details of the intercepted messages that may be relevant to the process failure in a collected message data store that contains electronic records representing details of the intercepted messages that may be relevant to the process failure;
accessing, by a message recorder, information from the collected message data store; and
arranging, by the message recorder, for information about the recorded messages to be transmitted, via a distributed communication network, to a support team via a Graphical User Interface (“GUI”) display.

17. The media of claim 16, wherein the message recorder provides at least some of the information about the recorded messages to a generative Artificial Intelligence (“AI”) Large Language Model (“LLM”).

18. The media of claim 17, wherein a LLM prompt includes at least some code base of the process executed by the enterprise.

19. The media of claim 18, wherein a response received from the LLM includes possible troubleshooting information to fix the code base.

20. The media of claim 19, wherein at least one of the message interceptor and the message recorder comprise a component that is plugged into cloud applications for design, development, and/or execution of business processes.

21. The media of claim 20, wherein at least one of the message interceptor and the message recorder comprise a reuseable component that communicates with pre-trained LLMs to generate a set of solution proposals based on real-time incident data.
